(19) United States
(12) Patent Application Publication
(10) Pub. No.: US 2024/0183044 A1
(43) Pub. Date: Jun. 6, 2024

(54) HYDROLYZER

(71) Applicants: Pietro DE DONNO, Maglie (LE) (IT); Raffaella PETTI, Pavia (PV) (IT); Francesco RAMAIOLI, Pavia (PV) (IT); ROTOMOTO S.R.L., Pavia (PV) (IT)

(72) Inventors: Pietro DE DONNO, Maglie (LE) (IT); Raffaella PETTI, Pavia (PV) (IT); Francesco RAMAIOLI, Pavia (PV) (IT)

(21) Appl. No.: 18/554,088

(22) PCT Filed: Apr. 6, 2022
(86) PCT No.: PCT/IB2022/053199

§ 371 Date: Oct. 5, 2023

(30) Foreign Application Priority Data
Apr. 6, 2021 (IT) 102021000007694

(51) Int. Cl. C25B 9/65; C25B 1/04; C25B 9/77; C25B 15/08

(52) U.S. Cl. CPC C25B 9/66; C25B 1/04; C25B 9/77; C25B 15/08

(57) ABSTRACT

The invention is a hydrolyser capable of operating with simple water, instead of using demineralized water with chemical additions of salts and other compounds. It can use both spring water and any other type of water, such as drinking water, sea water or grey or waste water. Gets separate outputs of hydrogen and oxygen. It is proposed a mechanical and circuit solution which allows ionic migration between anodes and cathodes, such that it does not require the addition of potash or other salts or other chemical systems suitable for improving the conductivity of the water in the hydrolysis cell. The system allows a very wide parallel surface interface between anode and cathode, despite the physical distance between anode and cathode and their clear separation. The total resistance of the water for each hydrolytic cell is very low, i.e. a high conductivity through the water, conductivity obtained through the artifice of the so-called ionic bridge.

### FIELD OF TECHNIQUE

The present invention relates to a hydrolyser, that is to say a device for electrolysis of water. In particular, the hydrolyser in question is suitable for carrying out a high efficiency hydrolysis by generating hydrogen and oxygen in simple water, so as to create a hydrolysis system without salts and additives.

Hydrogen has recently become a privileged form of energy storage, because it is expected to replace other more polluting forms, both of use and of storage.

Even its simplest form derived from hydrolysis, HHO, or the production of hydrogen and oxygen already combined for immediate use, for example as an additive or as a propellant for a heat engine, has numerous advantages in terms of energy efficiency, recovering and also using 33% of oxygen produced and not dispersed or used otherwise, in case of immediate use for combustion or detonation.

In all cases, that hydrogen is produced separately or jointly with oxygen, the use of simple components such as ordinary water, not desalinated and not demineralized, increases environmental compatibility due to the absence of processing and of waste or waste that require energy and costs. The absence of chemical additives also increases compatibility with nature, avoiding the production of residual compounds that can impact the environment or require management and disposal costs.

### STATE OF THE ART

The state of the art and publications on hydrolysis are numerous, as well as patents. Many are dated over time, others are more recent because new materials and new sintering, synthesizing and production systems have greatly improved the technology of the materials available. Despite the simplicity of the invention, no comparable references to the present invention have been found. The literature and patents focus on AEM, PEM and similar cells.

In the research of the known art, some patent solutions have been highlighted, which we mention:
U.S. Pat. No. 9,353,451B2—A hydrolysis system for a vehicle engine includes an electrolysis unit having a plurality of spaced, generally parallel, conductive plates and an electrolyte between the plates that produce fuel gas including hydrogen and oxygen by electrolysis; a reservoir that receives the fuel gas from the electrolysis unit and stores the fuel gas and electrolyte; an electric pump that pumps the electrolyte from the reservoir to the electrolysis unit; a pulse width modulator that provides DC power to the conductive plates and to the pump; a dryer having a filter that removes water from the fuel gas; an expansion tank having an interior cavity that expands the fuel gas and a conduit within the cavity that heats the fuel gas with circulating hot water; and a spray tube that outputs the fuel gas. Methods include preparing and using the hydrolysis system.”
U.S. Pat. No. 9,574,276B2—In one embodiment, a process for electrochemical hydrogen production is provided. The process includes providing an electrochemical cell with an anode side including an anode, a cathode side including a cathode, and a membrane separating the anode side from the cathode side. The process further includes feeding molecules of at least one gaseous reactant to the anode, oxidizing one or more molecules of the gaseous reactant at the anode to produce a gas product and protons, passing the protons through the membrane to the cathode, and reducing the protons at the cathode to form hydrogen gas.”
CA2937948C—A high temperature electrolyzer assembly comprising at least one electrolyzer fuel cell including an anode and a cathode separated by an electrolyte matrix, and a power supply for applying a reverse voltage to the at least one electrolyzer fuel cell, wherein a gas feed comprising steam and one or more of CO2 and hydrocarbon fuel is fed to the anode of the at least one electrolyzer fuel cell, and wherein, when the power supply applies the reverse voltage to the at least one electrolyzer fuel cell, hydrogen-containing gas is generated by an electrolysis reaction in the anode of the at least one electrolyzer fuel cell and carbon dioxide is separated from the hydrogen-containing gas so that the at least one electrolyzer fuel cell outputs the hydrogen-containing gas and separately outputs an oxidant gas comprising carbon dioxide and oxygen.
CN101886270B—This document relates to the high pressure electrolysis cell for hydrogen manufacturing from water. Particularly, exemplary embodiment comprises the method and apparatus improving high pressure electrolysis cell electrolytic efficiency, it is by when high pressure electrolysis cell works, reduce anodic current density and reduce anodic overvoltage, reduce to penetrate through from cathode compartment the amounts of hydrogen that electrolytic bath membrane enters anolyte compartment simultaneously and realize.”

### Purpose of Invention

Simple water: the invention aims to contribute to improving the production of hydrogen and oxygen, in particular through the present artifice which allows simple water to be used, without the need for adding elements or compounds that improve the conductivity of the water itself. Therefore, the invention solves the problem of allowing the use of simple water in the hydrolysis cell or cells; sea water is however usable as are grey and waste water. The invention can be used in any system for separating fluids from the passage of current, including in the galvanic bath.

Single tank: a further problem that the invention solves concerns the possibility of realizing the hydrolysis system in a single tank, without separations into distinct cells, greatly simplifying the construction and its consequent costs, which are significantly reduced.

Different and programmable voltages and currents: another artifice corresponding to a further problem that it solves, concerns the possibility of using different voltages and currents, connecting the single new cells in series and/or in parallel, always within the same tank.

Cleaning of the conductors: the anode and cathode conductors, through an inversion of current polarity and/or through sonic and/or ultrasonic waves, are kept clean through the mechanical peeling of the surfaces, which are subjected to electromechanical shocks of the propagating waves through transducers and water. For example, piezoelectric transducers can be in mechanical contact with the anode and cathode conductors, or they can be in indirect contact through fluids, including water.

### SUMMARY OF THE INVENTION

In particular, the subject of the invention is a hydrolyser, comprising a tank for example in the form of a watertight container suitable for containing fluids such as water.

There is a plurality of bridging cells arranged inside the tank.

Each cell includes a stratiform anode and cathode mutually aligned along a prevailing direction of development, and at least one stratiform ion bridge, facing and parallel to the anode and cathode at a short distance from them.

At least one closing element is arranged at the top of the tank to define inside the latter, above the bridging cells, an anodic containment chamber and a cathodic containment chamber respectively located above the anodes and above the cathodes of the bridging cells.

A hydrogen passage duct is connected to one of the anodic and cathodic containment parts, and an oxygen passage duct is connected to the other of said anodic and cathodic containment parts.

All ion bridge cells are therefore contained in a single container, with a minimum potential difference applicable to each cell between anode and cathode, to produce hydrogen and oxygen separately.

The containment chambers can be mutually separated in such a way that the hydrogen gases bubbled on the side of the anodes above and collected by one chamber are separated from the oxygen gases bubbled on the side of the cathode above and collected by the other chamber.

In at least one convenient embodiment, the invention can also comprise one or more of the following preferential characteristics.

Preferably, the bridge cells are parallel to one after the other so that each bridge cell has the anode and cathode interposed between two ionic bridges.

Preferably, the closing element has a separator interposed between the anodic containment chamber and the cathodic containment chamber to obstruct the communication of the gases collected respectively in the anodic containment chamber and in the cathodic containment chamber.

Preferably, at least one separator membrane extending inside the tank and interposed between the anode and the cathode of each bridge cell is also provided, to allow ionic migration, partial electrical separation and separation of gases inside the tank.

Preferably, the separator is connected and extended by the separating membrane.

Preferably, the tank contains located on its bottom wall transducer elements capable of transmitting sonic and/or ultrasonic vibrations to the fluids contained in the tank.

Preferably, the anodes, cathodes, and ion bridges are adjacent or connected to the transducer elements.

Preferably, said transducer elements are at least two and can be activated independently of each other even with appropriately out of phase signals.

Preferably, the tank contains supports mechanically connected to a bottom wall thereof, which act as a rise and mechanically retain the anodes, cathodes, and ionic bridges.

Preferably, the anodes, cathodes, and ionic bridges are mutually connected and mechanically locked by locking through inserts.

Preferably, each locking through insert comprises respectively alternating conductive portions and insulating portions.

It is thus possible to make the electrical connections between the conductive parts and the electrical power supply elements, in order to provide the connection in series and/or in parallel of the bridged cells and the necessary electrical power supplies.

Preferably, each locking through insert is mechanically but not electrically connected to one or more of said ionic bridges.

Preferably, the anodes, cathodes, and ionic bridges are kept separate and connected mechanically but not electrically to each other by locking through inserts.

Preferably, the ionic bridges are placed at a close distance with respect to the anodes and cathodes of the respective bridge cells, so that the electrical resistance due to the mutual facings between the ionic bridges and cathodes and anodes is sufficiently low so that the non-demineralized water does not need chemical additions to increase its conductivity.

In this way, the hydrolyser is allowed to work with only water, which is not demineralized, simultaneously producing and collecting hydrogen and oxygen gas in two separate points respectively in the anodic and cathodic containment chamber, which overhang and close the container.

Preferably, the anode and cathode of each bridge cell are mutually coplanar.

Preferably, in each bridge cell the ion bridge is placed at a voltage equal to approximately half of a voltage applied between anode and cathode to produce hydrogen and oxygen.

The ion bridge can therefore be polarized in such a way as to produce neither hydrogen nor oxygen, that is, it is neutral and only serves for the passage of electrons and ions.

Although the anode and cathode are spaced on the same plane, they can therefore have a mutual facing comparable to the one with an anode and cathode mutually facing each other directly as shown in the figure, but in a spaced and shifted position to one side, to allow the collection of gases in a separate and spaced way.

Preferably, electrical power supply devices are also provided, for example dividers, diodes, Zener, to apply an electrical voltage between the anode and cathode of each bridge cell.

Preferably, each of said anodes, cathodes and ionic bridges is made in the form of a conductive net and/or has a reticular surface structure.

The passage of electric currents, fluid dynamic currents, ionic exchanges is thus facilitated.

Preferably, the net or grid that creates the conductive surfaces indicated above, can be made from meshes whose wires have a diameter or thickness from 0.5 mm to 1.5 mm, with opening of the hole (or holes) of the mesh with side or diameter from 0.5 to 1.5 mm.

Preferably, the sonic and/or ultrasonic transducers can be activated synchronously to clean said anodes, cathodes, and ionic bridges from polluting elements, and/or in an out of phase manner to cause fluid movements in the water or other electrolytic fluid contained in the tank.

Preferably, the anodic containment chamber and the cathodic containment chamber are communicating with each other, and/or the separator is permeable to gases, for the production of mixed hydrogen and oxygen gases.

It is thus possible to carry out the production of the so-called HHO gas.

In other words, a hydrolyser is provided consisting of a watertight container suitable for containing fluids such as water closed by lids. A lid in turn is connected to a hydrogen passage tube, a lid is in turn connected to an oxygen passage tube. A lid can be connected to a separator connected in turn to the other lid, such that the separator prevents the communication of the gases contained by the lids.

Said lids are therefore separated in such a way that the hydrogen gases bubbled on the side of the anodes above and collected by one cover are separated from the oxygen gases bubbled on the side of the cathode above and collected by the other cover.

Preferably, the separator is connected and extended by an optional separating membrane which allows ionic migration, partial electrical separation and gas separation.

Preferably, said container contains located on the bottom transducer elements capable of transmitting sonic and ultrasonic vibrations to the fluids contained in the container, such as for example transducers.

Preferably, these transducers must be at least two and capable of operating separately also controlled by suitably out of phase signals.

Preferably, said container contains suitable supports mechanically connected to the bottom of the container itself, which act as a rise and mechanically hold the conductive elements which act as anode, cathode, ion bridge, said conductor elements are close to or connected to the transducers.

Preferably, said conductive elements are held together and mechanically locked by constraints and joints, such as for example multiple locking throughs.

Preferably, said locking throughs are alternately conducting and insulating, in order to make the electrical connections between the conductive parts and the electrical power supply elements, in order to provide the series and/or parallel connection of the cells and the necessary electrical supplies.

Preferably, said locking through is mechanically but not electrically connected to the conductive surface which acts as an ion bridge, facing and parallel on one side to the anode surface and facing and parallel on the other side to the cathodic surface.

Preferably, said surfaces are kept separate and connected mechanically but not electrically by multiple locking throughs.

Preferably, said multiple locking throughs support a multiple repetition in succession of the ion bridge, anode and cathode, in order to constitute the defined ion bridge cell, replicated several times, with care that each cell is composed of anode and cathode contained between two ionic bridges.

Preferably, said constructive configuration consisting of the aforementioned parts and thus connected as described, is suitable for ensuring that the electrical resistance due to the faces between ionic bridges and cathodes and anodes is sufficiently low so that the water does not require chemical additions to increase its conductivity, thus allowing the hydrolyser to work with only water, which is not demineralized, simultaneously producing and collecting hydrogen and oxygen gas in two separate points respectively in the lid, which overhang and close the container.

Preferably, the ion bridge cell consists of two parallel conductive elements which act as an ion bridge for the exchange of electrons and ions, which contain between them in the free spaces and in a parallel way, in the internal surfaces, both anode and cathode, spaced and aligned on the same plane according to FIG. 3, connected mechanically but not electrically through multiple locking throughs, immersed in water fluid.

Preferably, the ion bridge is polarized in such a way as to produce neither hydrogen nor oxygen, i.e. it is neutral and only serves for the passage of electrons and ions, because it is placed at a voltage equal to approximately half of the minimum necessary for the anode and cathode to produce hydrogen and oxygen in a separate and spaced way.

Therefore the anode and cathode, despite being spaced on the same plane, have a mutual facing comparable to that set up by the anode and cathode facing directly as in FIG. 2, but in a spaced and side-shifted position that allows the gas to be collected in a separate and spaced way.

Preferably, the ion bridge cell is replicated several times inside the same container, to create and use different ion bridge cells in series and/or in parallel, to use the desired voltages and currents, voltages which increase if the cells bridged cells are put in series, currents that increase if the ion bridged cells are put in parallel, and can be combined as desired in a mix of series and parallel.

Preferably, all the ion bridge cells are contained in a single container, without a physical separation between cell and cell, due to the fact that each cell has the minimum potential difference to produce hydrogen and oxygen separately.

Preferably, said voltages are guaranteed by dividers, diodes, Zener and/or separate power supplies for each cell, including the sequential dividers made by the resistances constituted by the conductive surfaces immersed in the aqueous fluid.

Preferably, the surfaces of the ionic bridges are at a voltage equal to approximately half the voltages of the cathodes and anodes which directly interface and which they contain. This characteristic is reproduced on all the ion bridge cells contained in the container.

Preferably, the conductive surfaces are made of a conductive net or with surfaces similar in shape to the net, such that the passage of electric currents, fluid dynamic currents, ionic passages is possible.

Preferably, the sonic and ultrasonic transducers work synchronously to clean the surfaces from polluting elements such as limestone, alternatively they also work out of phase to cause both vertical and horizontal fluid movements.

Preferably, the separator is gas permeable or removed, for the production of mixed hydrogen and oxygen gas, for the production of the so-called HHO gas.

Preferably, the separator is connected and extended by a separating membrane, which allows ionic migration, partial electrical separation and gas separation.

### BRIEF DESCRIPTION OF THE DRAWINGS

Further characteristics and advantages will become more apparent from the detailed description of a preferred but not exclusive embodiment of a hydrolyser according to the present invention. This description will be set out below with reference to the accompanying drawings, provided for indicative purposes only and, therefore, not limitative, in which:

FIG. 1 schematically shows a perspective view of a hydrolyser made according to the known art;

FIGS. 2a and 2b show, respectively in perspective and plan view, the anodes and cathodes of a variant embodiment of a hydrolyser;

FIGS. 3a and 3b show, respectively in perspective and plan view, a plurality of ion bridge cells forming part of a hydrolyser according to the present invention;

FIG. 4 schematically shows in plan, the ion bridge cells with the respective electrical connections;

FIGS. 5a and 5b show, respectively in perspective and plan view, further details of the plurality of cells according to FIGS. 3a and 3b;

FIGS. 6a and 6b are an overall representation of a hydrolyser according to the present invention, respectively in perspective and side view in transparency.

### DETAILED DESCRIPTION OF PREFERRED EMBODIMENTS OF THE INVENTION

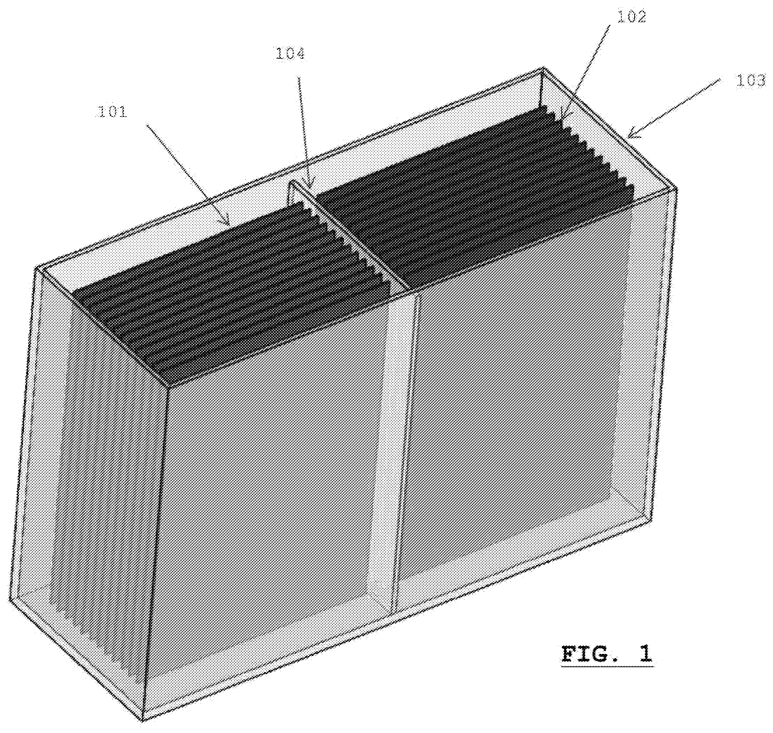

The standard hydrolytic cell of the known art is very simple as a concept, it is built through an anode 101 and a cathode 102 as in FIG. 1, immersed in a potassium hydroxide solution, also known as potash, all contained in a suitable container 103 which allows the separation and collection of the hydrogen and oxygen gases, well separated through the membrane 104. The gases may possibly also not be separated for the production of HHO, ie hydrogen and oxygen extracted together. As an alternative to potash, many other chemicals and elements are also possible to ensure the conductivity of the water element, in order to increase the passage of current and that this activates the generation of hydrogen and oxygen. Acids, bases and salts are suitable for the purpose, used by cells prior to the present invention. The standard hydrolytic cell of the known art is achievable in many ways and with many divisions and subdivisions. It is represented here in the simplest way to expose subsequent concepts and applications.

To explain the origins of the solution of the invention, it should be noted that in industrial electronics, screen printing pastes, which are conductive, semiconductive and resistive, have been used for many years, whose rheology allows the definition of the parameters of electrical, electromechanical and electronic behaviour. These pastes are used to create circuits, resistors, semiconductors paths, typically on ceramic surfaces made of aluminium dioxide (alumina) technical ceramic

The rheology of such materials has, among others, a characteristic parameter expressed in “Ohms/Square”.

Even water has its own rheology, even if up to now this term has not been used to define water, at least it could be inappropriate before the present technological solution of the invention existed.

In the characterizations of drinking water, conductivity is expressed in Siemens, typically due to the minerals contained. The conductivity values are normally reported in the chemical analyses of drinking water, present on the labels of the bottles.

By transmuting the concept of ohms/square also in the hydrolysis circuit, the measurement of water conductivity in volumes can be related to the cubic centimetre. Therefore, with the same distance between cathode and anode, the larger the surface in contact with water, the greater the conductivity and the lower the resistance between the immersed conductors.

The artifice of the invention lies precisely in allowing a direct mutual facing between anode and cathode, greatly increasing the directly facing and parallel surfaces. From now on we will call this mutual direct facing between anode and cathode as “efficient facing” or also “efficient interface”. The mutual facing is conceptually comparable and achievable like the surfaces of a condenser.

Although the traditional physical and clear separation between anode and cathode allows a decisive separation between hydrogen and oxygen, as shown in FIG. 1, this separation greatly reduces the available conductivity and greatly increases the resistance of the system, thus requiring the use of a increased conduction of the liquid water which therefore requires the addition of elements or compounds that improve conductivity.

Other solutions similar to the one described in the standard of known art are achievable, but conceptually the separation remains clear. The AEM (anion exchange membrane) cells, the PEM (proton exchange membrane) cells and the AEL (alkaline electrolysis) cells need to use chemical elements to be added to the demineralized water that increase its conductivity, in addition to physical separation, in special containers. or separators, of each cell.

The conductivity of the water is also accompanied by the wettability of the surfaces used for the measurement: the more a surface is penetrated by water, the greater the conductive response for the same surface, even smaller surfaces can increase the conduction of water for the same distance. Therefore, with the same surface and distance between the plates, the conduction of water will be greater (and less resistance), if the wettability of the surfaces used is greater, thanks to a greater interpenetration between water and materials.

Therefore, in order to use this device in the invention, a conductive mesh-forged material was used, because the mesh allows a greater interpenetration between surface and water, as well as allowing other phenomena indicated below in various points of the text. Using a stainless steel mesh with 1.5 mm square holes, made with 1 mm diameter wire, the wettable surface is 20% greater, i.e. 1.2 times greater than the same flat surface made solid, without holes. The network also allows the passage of conductive and ionic communication and the flows of the fluids involved. From now on we will call this efficiency linked to the wettability of the surfaces as an “efficient surface”. The mesh or grid that creates the conductive surfaces indicated above can be made from meshes whose wires have a diameter or thickness from 0.5 mm to 1.5 mm, with opening of the hole (or holes) of the mesh with side or diameter from 0.5 to 1.5 mm.

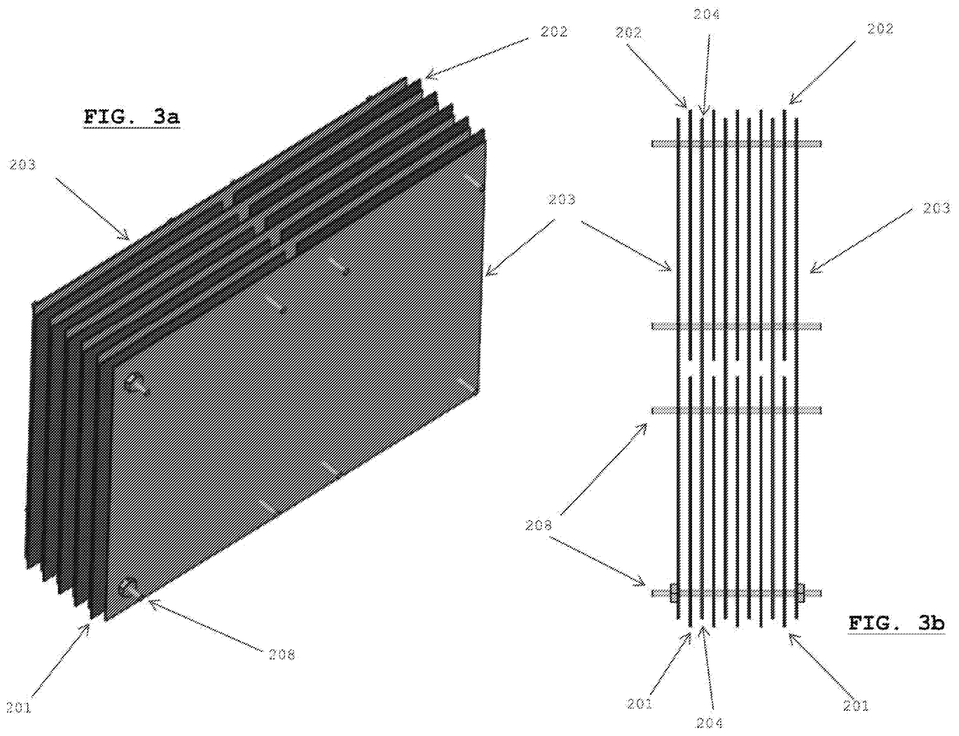

Therefore, with particular reference to FIGS. 3a to 6b the construction of the invention sees the cathode 201 and the anode 202 having a stratiform structure constructed preferably with the net described above, as well as a new element stratiform that we are going to introduce is also built with a net, that is what we have defined “ion bridge”, or a similar surface with anode and cathode, indicated to in FIGS. 203 and 204.

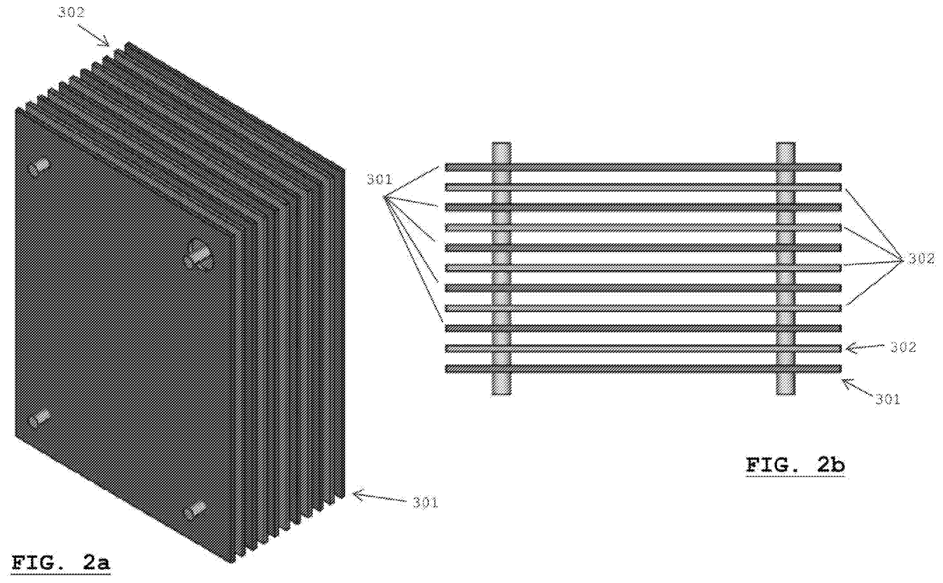

The mutual facing between the anode and cathode can be direct, in the case of a cell made up of only two elements, or in the case of each cell composition as in FIGS. 2a and 2b, where anode and cathode are respectively indicated with 301 and 302.

The mutual facing of the invention between cathode 201 and anode 202 is facilitated by the surface of the ion bridge 203, which allows the migration of ions and electric charges.

In the known art, to obtain an “efficient facing”, anode 301 and cathode 302 must be facing and close together as in FIGS. 2a and 2b, compromising the division between oxygen and hydrogen, which risk mixing. The greater the production need, the greater the surfaces required, multiple as shown in the figure. Therefore, to use only water, it will be necessary to ensure that the surfaces are close to improve conductivity, but at the same time they are distant for the separation of gases. In the present invention, to obtain both results, that is the separation of the surfaces between anode 201 and cathode 202 and to separate the hydrogen and oxygen gases, as well as to obtain the direct and electrically close facing surface and for obtain the ionic passage, a ionic bridge 203 is used.

The anodes 201 and cathodes 202 of FIGS. 3a and 3b, mutually coplanar or in any case aligned along a prevailing development direction, will still be separate and distant between them, like the anodes and cathodes 101 and 102 in FIG. 100, but they also will face a surface of ionic bridge 203 having an extension approximately equal to the sum of the two anode surfaces and cathode, that is a single conductive and short-circuited surface which creates the electrical and ionic passage between anode and cathode, which creates the said “ion bridge” 203 between anode 201 and cathode 202. Therefore, we define from now on the term “ion bridge” as a single surface, preferably in a conductive net, which faces both the entire surface of the anode and the entire surface of the cathode, allowing a distance and a physical separation between the two surfaces, however electrically and ionically joined through an “efficient view” achieved through the “ion bridge” itself.

The cell made from anode 201 and cathode 202 mutually facing indirectly through almost one ion bridge 202, will be called and defined from now on as “ion bridge cell” or simply “bridge cell”, as a whole denoted by 200.

The total resistance, between anode 201 and cathode 202, will twice that which would be obtained with cathode and anode mutually facing directly at a distance equal to that between the ion bridge 203 and each of said anode and cathode, because the distance between anode and cathode is double through the conductor of the “ion bridge” 203.

By doubling the “ion bridge”, i.e. by including anode 201 and cathode 202 between two aforementioned ionic bridges 203 and further ionic bridge 204, as in FIGS. 200 and 400, the total resistance will be halved, because the conduits across the ion bridge which is double for each bridge cell 200 composed of anode 201 and cathode 202 placed on the same plane.

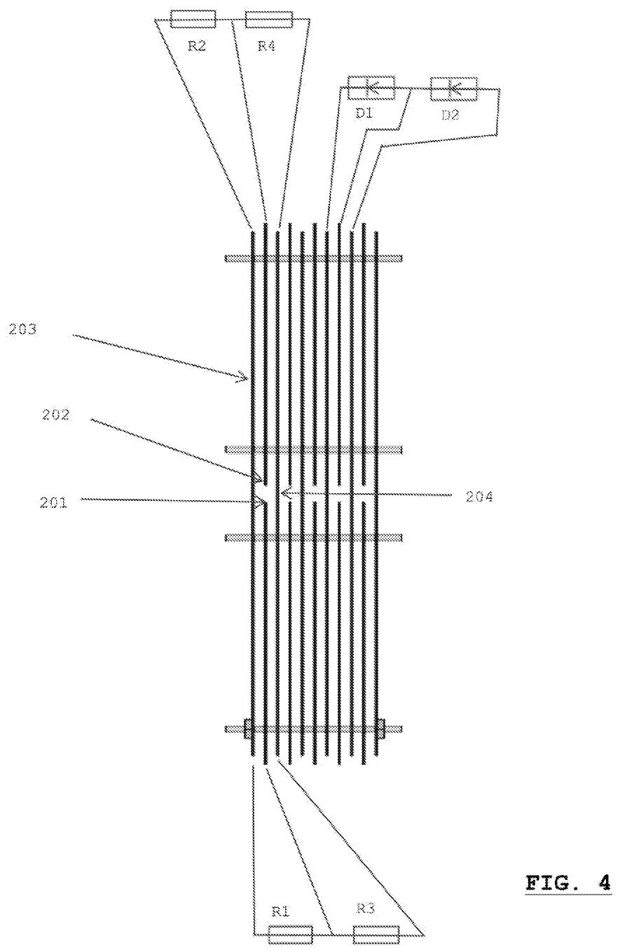

In FIG. 4, a first, a second, a third and a fourth electrical resistance are schematically represented with R1, R2, R3 and R4 represented by the conductivity of the water that occupies the space between anode 201, cathode 202, ion bridge 203 and the further ion bridge 204. As shown in FIG. 4, resistor R1 and resistor R2 are connected in series with each other across the ion bridge, but R1 is in parallel with R3 and resistor R2 is in parallel with resistor R4, this placing the ionic bridges 203 and 204 in short circuit together between each, that is placing the same 203 and 204at the same electric potential.

The electric circuit therefore consists of: anode 201 connected to an ion bridge 203 through the resistance R1 which represents the conductivity of the water interposed between the faces of the anode 201 and the faces of the ion bridge 203; this ion bridge 203 is a conductor connected to the resistance R2 which is connected in turn to the cathode 202, where the resistance R2 represents the conductivity of the water between the faces of the ion bridge 203 and the faces of the cathode 202; the cathode 202 is in turn connected to the further ion bridge 204 through the equivalent resistance R4, which represents the conductivity between the surfaces of the cathode 202 and the surfaces of the ion bridge 204; the further ion bridge 204 is a conductor and is in turn connected to the anode 201 through the equivalent resistance R3, which represents the conductivity of the water between the surfaces of the ion bridge 204 and the surfaces of the anode 201.

Therefore, if the resistances R1, R2, R3, R4 are equivalent, when a voltage Vcc is applied between anode 201 and cathode 202, the voltage between anode 201 and ion bridge 203 will be ½ *Vcc, that is half of the supply voltage Vcc, as well as the voltage between the ion bridge 203 and cathode 202 will be half of Vcc. In fact, the ion bridge 203 is connected to the center of the resistive divider consisting of R1 and R2, which being equal, bring the supply voltage between anode 201 and cathode 202 to half. The divider consisting of R3 and R4 works in the same way. Therefore, if ion bridge 203 is short-circuited with further ion bridge 204, the equivalent resistances R1 and R3 are in parallel, lowering the resulting resistance between the two, thus increasing the current that can pass between anode 202 and ion bridge 203, 204 and then also between ion bridge and cathode 202, because R2 and R4 will also be in parallel. If the ionic bridges 203 and 204 were not short-circuited, they would in any case be at the same electric potential equal to a voltage which is half of the supply voltage, that is Vcc divided by two.

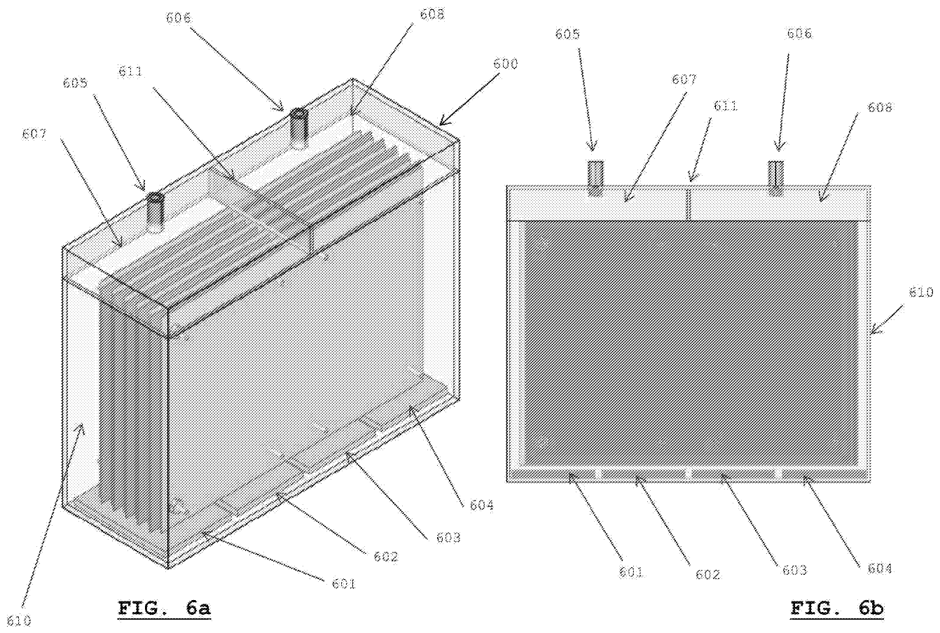

In this way the anodes 201 and the cathodes 202 are grouped on either side of the tank or other watertight container 610 (FIG. 6) in which they can be inserted, allowing the collection of hydrogen and oxygen, separately, taken from the top of each of the parts. A membrane analogous to the membrane 104 permeable to ions and impermeable to hydrogen and oxygen gases can be possibly inserted between the cathode 201 and anode 202, but it is not necessary except for the high degrees of purity of the gases that may be required.

This arrangement guarantees the mechanical and physical distance between anode 201 and cathode 202, but at the same time guarantees the shortest possible electrical distance through the ion bridge 203, assisted by the similar further ion bridge 204. This mutual facing through the ion bridge guarantees “efficient conduction” even in plain water, even if the cathode and anode are far apart and separated, without direct mutual facing.

The minimum hydrolysis voltage V1=Vcc is the one that triggers a passage of current sufficient to start the hydrolysis process between anode 201 and cathode 202.

In the absence of salts or elements that favor conduction (salts, acids, bases, metals, doped semiconductors), the working voltage for water alone is greater than the typical voltage of a standard hydrolytic cell.

With local drinking water, rich in minerals and calcium, the cell voltage can be approximately 5 Volts, such that the passage of current is sufficient to generate a conspicuous production of the two gases, in the case of use of a surface and of a distance proportional to the cell power to be used to generate the gases.

From now on, the term “useful cell voltage” VU is defined, that voltage parameter for which the hydrolysis process starts with the production of hydrogen at the anode 201 and oxygen at the cathode 202, in an adequate mode in the absence of salts or chemical additions.

If the useful cell voltage VU is 5 Volts between anode and cathode (V 201-202) to trigger the electrolysis process, the voltage between anode 201 and ion bridge 203 (V 201-203) must be equal to the voltage between the bridge ionic 203 and cathode 202 (V 203-202) and equal to half the useful cell voltage.

In this way the voltage between anode 201 and ion bridge 203 is equal to half of the useful voltage VU, i.e. VU*½ or VU/2, therefore this voltage is not sufficient to trigger a hydrolysis process between anode 201 and bridge ion 203. Equally also the voltage between the ion bridge 203 and cathode 202 must be equal to half the useful voltage VU, ie VU/2, so as not to obtain gas generation between the ion bridge 203 and cathode 202.

The balancing of the voltages on the ion bridge, equal to half of the cell voltages VU, is suggested for maintaining the balance of the system as a whole, but it is not binding, i.e. lower voltages than VU are possible, even if unbalanced or non-symmetrical between the bridge ion and anode and cathode, as long as the voltage on the ion bridge is insufficient for the production of hydrogen or oxygen.

Despite the lack of gas production on the surface of the ion bridge 203, 204, the passage of electrons and ions is guaranteed by the same surface of the ion bridge, obtaining an effect similar to the direct facing between anode 201 and cathode 202, despite having anode and cathode with strong spaced apart.

In this way, the desired effects are obtained, i.e. the four conditions facilitated by the invention: 1) the efficient mutual facing, 2) the efficient surface, 3) the efficient conduction, 4) the gas separation 5) the possibility of use in the tank only.

The use of plain water without salts can implies some problems such as the deposits of impurities that tend to cover the conductive surfaces, reducing the conductivity of the materials used. The typical phenomenon is the deposit of limestone.

To solve these aspects or problems, a double solution has been found, which can also be used in combination.

The first solution concerns the inversion of the cyclic polarity of the cells, electronically or electromechanically inverting the polarity of the cells. Thus, cyclically the anode is transformed into a cathode and the cathode is transformed into an anode, as well as the outputs 605 and 606 of the gases in FIG. 600 are switched, by means of an appropriate inversion solenoid valve.

The second solution concerns the use of ultrasounds, designed to move the particles of impurities deposited on the anode, cathode and ion bridge conductors of the cell. Some ultrasound generators feed the ultrasonic and/or infrasound transducers 601 602 603 604, for example piezoelectric ones, placed on the bottom wall of the bridge cell 200 or tank 610. If the transducers operate at the same time, this transducer operation occurs in a mode defined “synchronously”.

Like an ultrasonic washing machine, the sound waves clean the conductive surfaces of the bridge cell 200.

The use of multiple transducers 601 602 603 604 respectively distinct and/or separate allows an alternation to increase the cleaning efficiency through a phase shifted wave. To achieve this, the transducers 601 and 603 e are preferrably powered and controlled simultaneously by the same signal, while the transducers 602 and 604 are powered and controlled simultaneously by a further signal realized in counterphase or out of phase with respect to the stimulus of the transducers 601 and 603. In this way a horizontal transverse wave is generated to move the fluids through the networks, which is combined with the typically vertical movement of the single stimulus. This operation of the transducers in push-pull or out of phase occurs in a mode defined as “asynchronously”.

As already said, a further artifice and problem solved by the present invention is that of using, inside a single tank 610, a series of cells which can be positioned inside the same tank without any separation. The cell in this case is the ion bridge cell 200, composed of anode 201, ion bridge 203 and further ion bridge 204, cathode 202. Preferably, two contiguous cells 200 share the same further ion bridge 204. These cells can be multiple and placed in series or in parallel with each other, depending on the voltages and currents that they are to be used to produce hydrogen and oxygen. At the top of the tank 610 there is at least one closing element 600 in the form of a hollow container separated into two containment parts, respectively anodic 607 and cathodic 608, respectively located above the anodes 201 and above the cathodes 202 of the bridging cells 200, capable of separately collecting hydrogen from the anode side and oxygen from the cathode side.

The containers parts 607 and 608 are watertight towards the top and sides, while they are open towards the bottom and closed exclusively by the liquid fluid such as water, to receive the gases that bubble from the ion bridge cell. To the anodic containment part 607 and to the cathodic containment part 608 respectively connected are a hydrogen passage duct 605 and an oxygen passage duct 606. Through the ducts, in the form of tubes 605 and 606 which each engage respectively in one of the containment parts 607, 608, the hydrogen and oxygen gases are extracted, even in a forced and/or independent manner. Between parts 607 and 608, there is a suitable divider 611 which separates the parts and gases. The partition 611 can be extended by a dividing membrane 104 to the bottom of the container, for a further separation between hydrogen and oxygen in case a high purity of hydrogen and oxygen is required. In this case, the membrane 104 is used as an extension of the partition 611 will be crossed by the surfaces of the ionic bridges 203, 204.

The separators 611 and 104 can be permeable to gases or removed, for the production of mixed hydrogen and oxygen gas, for the production of the so-called HHO gas.

In the example illustrated, the bridging cells are five, as five are the anodes 201 and five are the cathodes 202, while the total number of the ion bridges 203 and further 204 are six, to completely contain the anode 201 and cathode 202 and interface them through two ion bridge surfaces 203, 204 for each cell 200, in order to halve the resistance between anode and cathode.

In order to ensure the correct voltage setting between the anode and cathode conductors and the ion bridge, a suitable circuit is interposed between them to impose the correct voltages, in order to neutralize the production of gas on the ion bridge 203, 204 and subsequent ones.

In case of series between bridged cells 200, these will be driven by circuits that impose the correct voltages for each bridged cell. The general power supply voltage derived from the sum of the cells can also be divided by resistive dividers and/or diodes and/or zener diodes D1 and D2 (FIG. 4), which guarantee the voltage for each anode 201and cathode 202, as well as guarantee the voltage for each anode and ion bridge, as well as the voltage for each ion bridge and anode. External power supply circuits can also guarantee the correct power supplies for each component of the system, in order to neutralize the voltage of the ion bridge 203, 204 which must not produce gas, but only conduct ions and electrons.

The number of cells 200 and their dimensions are easily adaptable to the power required to be used to produce the gases. Within the same hydrolytic tank 610, the various bridging cells 200 can be combined in series and/or in parallel, allowing the operating parameters to be varied in terms of voltage and current. By making several cells in series, even within the same container, the operating voltage will be raised, by putting more cells in parallel, the current capable of being absorbed or consumed will be raised. The correct combination of series and parallel will make it possible to use different voltages and currents of use, to determine the power to be engaged or used.

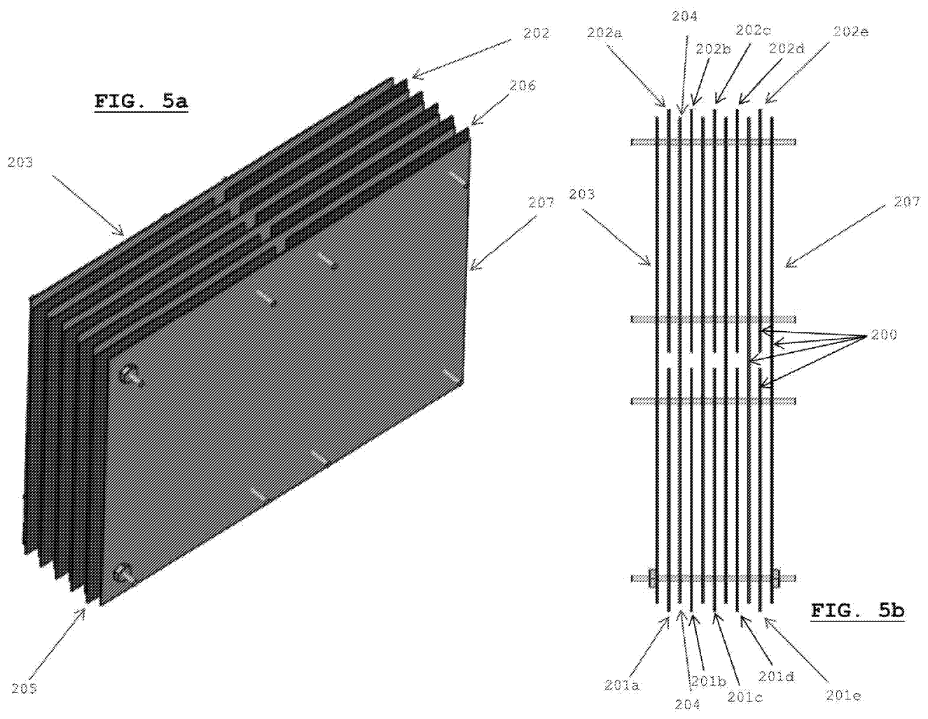

In FIG. 5, with the suffix a, b, c, d, e, the anodes 201 and the cathodes 202 each belonging to one of the ion bridge cells 200, respectively from the first to the fifth or last cell, subsequently placed side by side in succession. The anodes 201a . . . e can be powered at the same voltage, at the negative end, while cathodes 202a . . . e are powered at the same voltage, at the positive end. In this way there are 5 cells made with a ion bridge 200, at a single common voltage.

As an alternative to the above, a higher supply voltage can be connected between anode 201a of the first cell and cathode 202e of the fifty and last cell. realizing five cells 200, powered in series. Therefore the necessary power supply will be multiplied by 5 times, with respect to the voltage required when the anodes and cathodes are instead powered at the same voltage. If 5 volts are needed for the cell with common anodes and cathodes, in the series cell it will need 25 volts. The power supply voltage obviously varies as a function of the distance between the components of the cells 200 and as a function of the surface area. The number of ion bridge cells 200 can also be very high, typically confined to a single container of water. In fact, the greater current will pass through the combination of ion bridge cells, making the isolation of the individual ion bridge cells of the system useless, which can thus be placed in a single tank 610.

If the physical dimensions of the components parts of the cells are symmetrical, the voltage difference between the anodes 201 and the ionic bridges 203, 204 that contain the anodes themselves, will always be equal to half the voltage between the anode 201 and the cathode 202 of the same cell 200, preventing the generation of gas on the surfaces of the ionic bridge concerned, as well as for the successive and contiguous ionic bridges.

To be sure of the correct power supply, or to compensate for dimensional or shape or distance differences, it is possible to separately power each cell making up the series of cells with independent energy sources.

As alternative to the independent power supply of each cell, it is possible to connect the series of the cells with resistive dividers and/or with diodes in series or zener diodes, as for example in FIG. 4 which shows the diodes D1 and D2, in order to impose for each cell, composed of anode and cathode enclosed between two ionic bridges, the correct voltage and, at the same time, that the voltage between the ionic bridges is halved with respect to the anode and cathode of the same cell, but also between anode and cathode of the next or previous contiguous cell.

Cleaning the electrodes and maintaining an adequate cleaning quality of the liquid fluid such as water, used for hydrolysis, requires an internal or external active filtering system, which will filter the fluids and possibly cool the internal fluids.

The maintenance of the levels can be guaranteed by a water supply system, such as a tank, which can provide compensation for liquid fluids such as water transformed into hydrogen and oxygen.

### The Best Way to Build the Invention:

The hydrolyser comprises a watertight container or tank 610 suitable for containing fluids such as water closed by at least one closing element 600 in the form of a hollow container divided into two containment parts or lids 607 and 608, anodic and cathodic respectively. The anodic lid 607 is connected to an hydrogen passage tube 605, communicating with the inside of the tank 610, while the cathode cover 608 is connected in turn to an oxygen passage tube 606 also communicating with the inside of the tank 610.A separator 611 is connected between the first lid 607 and the second lid 608 such that separator 611 prevents the communication of the gases contained by covers 607 and 608; said lids 607, 608 are therefore separated in such a way that the hydrogen gases bubbled on the part of the anodes 201 overlying and collected by the lid 607 are separated from the oxygen gases bubbled up by the part of the cathode 202 and collected by the lid 608; the separator 611 can be connected and extended by an optional separator membrane 104 which allows ionic migration, partial electrical separation and gas separation. Said container 610 contains located on the bottom transducer elements capable of transmitting sonic and ultrasonic vibrations to the fluids contained in the container, such as for example transducers 601, 602,603,604; such transducers must be at least two and able to function separately also controlled by appropriately out of phase signals. The container 610 can contains adequate supports mechanically connected to the bottom of the container itself, which act as a rise and mechanically hold the conducting elements that act as anode 201, cathode 202, ion bridge 203, 204. Said conductor elements are close to or connected to the transducers 601,602,603, 604. The same conductive elements are held together and mechanically locked by constraints and joints, such as for example a plurality of locking through inserts 208. Each of the through inserts 208 can be composed of alternately conductive and insulating portions, in order to make the electrical connections between the conductive parts and the electrical power supply elements, in order to provide and/or to determinate the connection in series and/or in parallel of the cells and the necessary electrical supplies. Each through inserts 208 is mechanically but not electrically connected to the conductive surface to ion bridge 203, 204, facing and parallel on one side (that of the anode cover 607) to the anode surface 201 and facing and parallel on the other side (that of the cathode cover 608) to the cathodic surface 202; The surfaces of ionic bridge 203, anode 201 and cathode 202 are kept separate and connected mechanically but not electrically between them by multiple through inserts 208. The multiple through inserts 208 support a multiple repetition in succession of ion bridge 203, anode 201 and cathode 202, in order to constitute the defined ion bridge cell 200, replicated several times, taking care that each cell is composed of anode 201 and cathode 202 contained between two ionic bridges 203.

Thanks to these constructive and positioning tricks, the electrical resistance due to the mutual facing between ionic bridges 203, 204 and cathodes 202 and anodes 201 is sufficiently low that the water does not require chemical additions to increase its conductivity, thus allowing the hydrolyser to work with water only, which can also be non-demineralised, simultaneously guaranteeing the production and collection of hydrogen and oxygen gas in two separate points respectively in the position of the anodic lid 607 and the cathodic lid 608, which overhang and close the container tank 610.

1. Hydrolyzer comprising:
a tank suitable for containing water or other electrolytic fluid;
a plurality of bridge cells arranged inside the tank, in which each cell comprises a stratiform anode and a cathode mutually aligned along a prevailing development direction, and at least one ionic bridge stratiform, facing and parallel to the anode and the cathode at a short distance from them;
at least one closing element arranged at the top of the tank to define inside the latter, above the bridge cells, an anodic containment chamber and a cathode containment chamber respectively located above the anodes and above the cathodes of the bridge cells;
a hydrogen passage duct connected to the anodic containment chamber;
an oxygen passage duct connected to the cathodic containment chamber.

2. Hydrolyser according to claim 2, in which the bridge cells are paralleled one after the other so that each bridge cell has the anode and the cathode interposed between two Ionic bridges.

3. Hydrolyser according to claim 1, wherein the closing element has a separator interposed between the anodic containment chamber and the cathodic containment chamber to obstruct the communication of the gases collected respectively in the anodic containment chamber and in the cathodic containment chamber.

4. Hydrolyser according to claim 1, further comprising at least one separator membrane extending inside the tank and interposed between the anode and the cathode of each bridge cell, to allow ionic migration, partial electrical separation and gas separation inside the tank.

5. Hydrolyzer according to claim 3, wherein the separator is connected and extended by the separating membrane.

6. Hydrolyser according to claim 1, in which the tank contains, located on its bottom wall, transducer elements capable of transmitting sonic and/or ultrasonic vibrations to the fluids contained in the tank.

7. Hydrolyzer according to claim 6, wherein the anodes, the cathodes, and the ion bridges are adjacent or connected to the transducer elements.

8. Hydrolyzer according to claim 6, in which said transducer elements are at least two and activatable independently of each other, even with appropriately out of phase signals.

9. Hydrolyser according to claim 1, wherein the tank contains supports mechanically connected to a bottom wall thereof, which act as a rise and mechanically retain the anodes, the cathodes, and the Ionic bridges.

10. Hydrolyzer according to claim 1, in which the anodes, the cathodes, and the ionic bridges are mutually connected and mechanically locked by means of locking through inserts.

11. Hydrolyzer according to claim 10, wherein each locking through insert comprises respectively alternating conductive portions and insulating portions.

12. Hydrolyzer according to claim 10, wherein each locking through insert is mechanically but not electrically connected to one or more of said ion bridges.

13. Hydrolyser according to claim 1, in which the anodes, the cathodes, and the ionic bridges are kept separate and connected mechanically but not electrically to each other by means of locking through inserts.

14. Hydrolyser according to claim 1, in which the ionic bridges are located at a close distance with respect to the anodes and cathodes of the respective bridge cells, so that the electrical resistance due to mutual facing between ionic bridges, cathodes and anodes, results to be sufficiently low so that the water does not require chemical additions to increase its conductivity.

15. Hydrolyzer according to claim 1, in which the anode and the cathode of each bridge cell are mutually coplanar.

16. Hydrolyzer according to claim 1, wherein in each bridge cell the ion bridge is placed at a voltage equal to approximately half of a voltage applied between anode and cathode to produce hydrogen and oxygen.

17. Hydrolyser according to claim 1, further comprising electrical power supply devices, for example dividers, diodes, Zener, for applying an electrical voltage between the anode and cathode of each bridge cell.

18. Hydrolyzer according to claim 1, wherein each of said anodes, cathodes and ionic bridges, is made in the form of a conductive net and/or has a reticular surface structure.

19. Hydrolyser according to claim 6, wherein the sonic and/or ultrasonic transducers are activatable synchronously to clean said anodes, cathodes and ionic bridges from polluting elements, and/or out of phase to cause fluid movements in the water or other electrolytic fluid contained in the tank.

20. Hydrolyser according to claim 1, in which the anodic containment chamber and the cathode containment chamber are communicating with each other, and/or the separator and is permeable to gas, for production of mixed hydrogen and oxygen gas.
